(19) United States
(12) Patent Application Publication
(10) Pub. No.: US 2025/0190696 A1
(43) Pub. Date: Jun. 12, 2025

(54) SEARCH SUPPORT METHOD

(71) Applicant: Semiconductor Energy Laboratory Co., Ltd., Atsugi-shi (JP)

(72) Inventors: Tatsuya OKANO, Isehara (JP); Junpei MOMO, Sagamihara (JP)

(21) Appl. No.: 18/964,764

(22) Filed: Dec. 2, 2024

(30) Foreign Application Priority Data
Dec. 8, 2023 (JP) 2023-207966

(51) Int. Cl. G06F 40/20

(52) U.S. Cl. CPC G06F 40/20

(57) ABSTRACT

A search support method using a language model is provided. The search support method includes a step of receiving a patent document and a first reference group; a step of obtaining a first overview extracted from the patent document and a plurality of second overviews each of which is extracted from any one of documents belonging to the first reference group; a step of inputting a first instruction sentence for outputting a similar point between the first overview and each of the plurality of second overviews to a language model; a step of dividing the first reference group into two or more second reference groups by performing clustering on the similar points and obtaining a label for each of the second reference group; and a step of deleting at least one of the two or more second reference groups based on the label.

### BACKGROUND OF THE INVENTION

### 1. Field of the Invention

The present invention relates to a search support method utilizing a language model, particularly, a generative AI model.

The above technical field is one embodiment of the present invention, and the present invention is not limited to the above technical field. Examples of other embodiments of the present invention include a semiconductor device, a display device, a light-emitting device, a power storage device, a memory device, an electronic device, a lighting device, an input device (e.g., a touch sensor), an input/output device (e.g., a touch panel), driving methods thereof, and manufacturing methods thereof.

### 2. Description of the Related Art

As a service using generative AI (Artificial Intelligence), ChatGPT can be given. Examples of large language models (LLM) used for ChatGPT are Generative Pre-trained Transformer 3 (GPT-3) and Generative Pre-trained Transformer 4 (GPT-4) (registered trademark).

As the performance of generative AI improves, the range of services using generative AI is expanding. For example, Patent Literature 1 proposes a document search support method that includes a display processing portion that displays an interactive guidance screen to a user in accordance with the user's operating history in searching a patent publication from a patent literature database.

### REFERENCE

### Patent Literature

[Patent Literature 1] Japanese Published Patent Application No. 2021-72009

### SUMMARY OF THE INVENTION

Even in the case where a user can find the appropriate search term, a large number of hits of patent publication requires much time to confirm the contents of the patent publications and increases a burden on the user. Patent Literature 1 regards increasing the number of hits of patent publications as a disadvantage, where narrowing down with another search term is performed. However, changing the search term might eliminate the hits of important patent publications from the search result.

The present invention has been made in view of the above problems, and an object of one embodiment of the present invention is to provide a novel search support method. Another object of one embodiment of the present invention is to provide a search support method that supports confirmation of a content of a patent publication which came up in the search.

The present invention does not necessarily need to achieve all of these objects. The description of these objects does not disturb the existence of other objects of the present invention. Other objects can be derived from the description of the specification, the drawings, and the scope of claims, for example.

In view of the above problems, one embodiment of the present invention is a search support method including a step of receiving a patent document and a first reference group; a step of obtaining a first overview extracted from the patent document and a plurality of second overviews each of which is extracted from any one of documents belonging to the first reference group; a step of inputting a first instruction sentence for outputting a similar point between the first overview and each of the plurality of second overviews to a language model; a step of dividing the first reference group into two or more second reference groups by performing clustering on the similar points and obtaining a label for each of the second reference groups; and a step of deleting at least one of the two or more second reference groups based on the label.

Another embodiment of the present invention is a search support method including a step of receiving a patent document and a first reference group; a step of obtaining a first overview extracted from the patent document and a plurality of second overviews each of which is extracted from any one of documents belonging to the first reference group; a step of inputting a first instruction sentence for outputting a similar point between the first overview and each of the plurality of second overviews to a language model; a step of dividing the first reference group into two or more second reference groups by performing clustering the similar points and obtaining a label for each of the second reference group; a step of inputting a second instruction sentence for outputting a different point between the first overview and each of the second reference groups to the language model; and a step of deleting at least one of the two or more second reference groups based on the label and the different point.

Another embodiment of the present invention is a search support method including a step of receiving a patent document and a first reference group; a step of obtaining a first overview extracted from the patent document and a plurality of second overviews each of which is extracted from any one of documents belonging to the first reference group; a step of inputting a first instruction sentence for outputting a first similar point between the first overview and each of the plurality of second overviews to a language model; a step of dividing the first reference group into two or more second reference groups by performing clustering the first similar points and obtaining a first label for each of the second reference group; a step of inputting a second instruction sentence for outputting a different point between the first overview and each of the second reference groups to the language model; a step of extracting a second similar point when a user cannot determine a second reference group to be deleted based on the label; a step of dividing the first reference group into two or more third reference groups by performing clustering the second similar points and obtaining a second label for each of the third reference groups; and a step of deleting at least one of the two or more third reference groups based on the second label.

Another embodiment of the present invention is a search support method including a step of receiving a patent document and a first reference group; a step of obtaining a first overview extracted from the patent document and a plurality of second overviews each of which is extracted from any one of documents belonging to the first reference group; a step of inputting a first instruction sentence for outputting a similar point between the first overview and each of the plurality of second overviews to a language model; a step of dividing the first reference group into two or more second reference groups by performing clustering the similar points and obtaining a label for each of the second reference group; a step of inputting a second instruction sentence for outputting a first different point between the first overview and each of the second reference groups to the language model; a step of extracting a second different point when a user cannot determine a second reference group to be deleted based on the label; and a step of deleting at least one of the two or more second reference groups based on the label and the second different point.

One embodiment of the present invention can provide a novel search support method. One embodiment of the present invention can provide a search support method that supports confirmation of a content of a patent publication which came up in the search.

The present invention does not necessarily need to have all of these effects. The description of these effects does not disturb the existence of other effects of the present invention. Other effects can be derived from the description of the specification, the drawings, and the scope of claims, for example.

### BRIEF DESCRIPTION OF THE DRAWINGS

FIG. 1 is a diagram illustrating a structure example of a system which enables a search support method of the present invention.

FIG. 2 is a diagram illustrating a structure example of a system which enables a search support method of the present invention.

FIG. 3 is a diagram illustrating a structure example of a data processing device which enables a search support method of the present invention.

FIG. 4 is a flowchart showing an example of a search support method of the present invention.

FIG. 5 is a diagram illustrating an example of a screen of an information terminal used for a search support method of the present invention.

FIG. 6 is a flowchart showing an example of a search support method of the present invention.

FIG. 7 is a flowchart showing an example of a search support method of the present invention.

### DETAILED DESCRIPTION OF THE INVENTION

Embodiments of the present invention will be described with reference to the drawings. Note that it is easily understood by those skilled in the art that modes of the present invention can be changed in various ways without departing from the spirit of the present invention. Therefore, the present invention should not be construed as being limited to the description in the following embodiments.

The position, size, range, and the like of each component in the drawings and the like do not accurately represent those of the actual component in some cases. Thus, the position, size, range, and the like of each component are not necessarily limited to those disclosed in the drawings.

In this specification and the like, the terms “first” and “second” are sometimes used for easy understanding of the technical contents or identification of components. Thus, the terms “first” and “second” do not limit the number of components. In addition, the terms “first” and “second” do not limit the order of components. In addition, the terms such as “first” and “second” or identification numerals used in this specification do not correspond to the terms or the identification numerals in the scope of claims of this application in some cases.

In this specification and the like, a document refers to a written representation of a person's intention with characters or symbols. The document includes in its category the state of being segmented into a plurality of sections or a plurality of paragraphs. One section may be composed of a plurality of paragraphs. In addition, in this specification and the like, a document to be a reference material for research is referred to as literature, and the literature includes publications such as treatises or journals.

In this specification and the like, a patent publication includes an application sheet necessary for a patent application, a specification attached to the application paper, and a document corresponding to the scope of claims attached to the application paper, and further includes a bibliographic information in the application paper, text data of a specification and the scope of claims. In this specification and the like, the text data may be obtained by optical character recognition (OCR) of a document file. A patent publication may include drawings attached to an application sheet and one or more selected from a formula, a chemical formula, and a table in a specification. A patent publication is linked to one or more numbers selected from an application number, a publication number, and a registration number given by the Patent Office.

In this specification and the like, a document relating to a patent includes a patent specification other than a patent publication and a document corresponding to the scope of claims. A document relating to a patent is typically a draft before application or an application form relating to a patent. The application form may be a document created by an inventor. The application form may be a document modified by a person other than the inventor, typically a person who belongs to the intellectual property department. The document relating to a patent may be referred to as a document that can be prepared before application to the Patent Office or before publication by the Patent Office.

In this specification and the like, documents relating to a patent publication and a patent are collectively referred to as patent documents. A document corresponding to a patent document includes a document that can be referred to literature.

In this specification and the like, a reference basically refers to a document that has been known before application of a patent, although there is a certain difference in the requirement for a reference among countries. A document corresponding to a reference includes a document that can be referred to as literature. In this specification and the like, two or more references are referred to as a “reference group”.

In this specification and the like, there is no limitation on the language of a document. The language is Japanese or a foreign language (e.g., English, Chinese, Korean, and German).

In this specification and the like, a language model is an interactive (also referred to as conversational) model based on a transformer architecture and obtained by additional learning. A typical language model is an LLM. The LLM performs processing based on supplied text data, specialized for a text generation function, and generative AI has not only text generation function but also image generation function based on image data.

### Embodiment 1

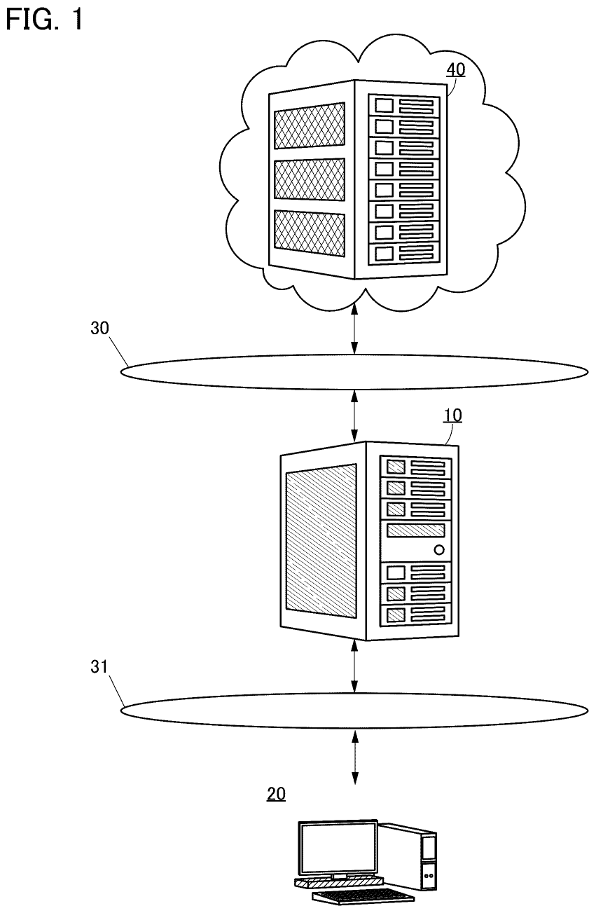

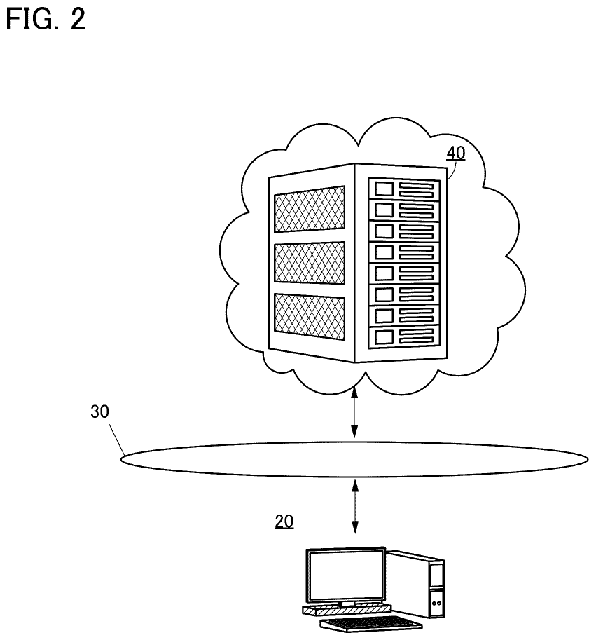

In this embodiment, structure examples of a system (referred to as a search support system) of one embodiment of the present invention which enables search support will be described with reference to FIGS. 1 and 2.

### <Structure Example 1 of Search Support System>

As illustrated in FIG. 1, a search support system of this embodiment preferably includes a first data processing device 10, a second data processing device 40, and an information terminal 20. The information terminal 20 is connected to the first data processing device 10 via a network 31 as illustrated in FIG. 1. The first data processing device 10 is connected to the second data processing device 40 through a network 30. In the search support system, the network 31 in FIG. 1 can be replaced with the network 30. That is, the first data processing device 10, the second data processing device 40, and the information terminal 20 may all be connected through the network 30.

### <Structure Example 2 of Search Support System>

The search support system of this embodiment may include the second data processing device 40 and the information terminal 20 without using the first data processing device 10 as illustrated in FIG. 2. The information terminal 20 is connected to the second data processing device 40 via the network 30 as illustrated in FIG. 2. The components included in the first data processing device 10 can be provided in the second data processing device 40. The components included in the first data processing device 10 may be provided in the information terminal 20. When components of the first data processing device 10 are included in the second data processing device 40 or the information terminal 20, the first data processing device 10 can be omitted. In the search support system, the network 30 in FIG. 2 can be replaced with the network 31. The network 30 and the network 31 will be described later.

### <<Structure Example of Information Terminal>>

In Structure example 1 and Structure example 2 of the search support system, the information terminal 20 is operated by a user and can be referred to as a client computer or the like. Although a desktop computer is illustrated as an example in FIG. 1 and FIG. 2, a laptop computer, a smartphone, or a tablet computer may be used as the information terminal 20. In the laptop computer, a housing including an input portion (typically, a keyboard) can be folded back to overlap with a main body. In addition, there is a laptop computer that can separate a housing from a main body. A laptop computer, a smartphone, or a tablet computer is easy to carry, and thus is suitable in the case where a user uses the search support system of one embodiment of the present invention at visiting places.

### <<Structure Example of First Data Processing Device 10>>

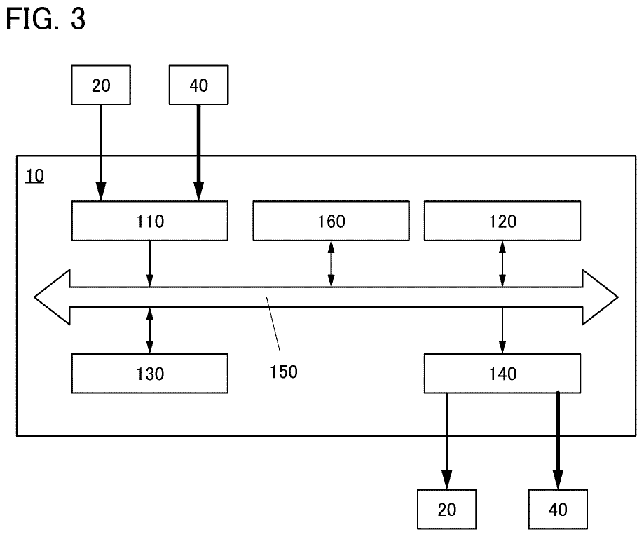

Next, a structure example of the first data processing device 10 is described with reference to FIG. 3.

The first data processing device 10 includes an input portion 110, a memory portion 120, a processing portion 130, an output portion 140, a transmission path 150, and a display 160 as illustrated in FIG. 3. Note that FIG. 3 illustrates the information terminal 20 and the second data processing device 40 in addition to the first data processing device 10, and arrows indicate data transmission and reception. The input portion and the output portion are collectively referred to as a communication portion in some cases. With the communication portion, the first data processing device 10 can transmit and receive data to and from the outside. Note that the first data processing device 10 does not necessarily include the display 160 when display of the search support system to the user is not needed.

### [Input Portion 110]

With the input portion 110, the first data processing device 10 can have a function of receiving data from the outside. For example, the input portion 110 can receive data from the information terminal 20. The input portion 110 can also receive data from the second data processing device 40. The input portion 110 can also receive data from other terminals or data processing devices. Examples of the data include document data corresponding to a patent document and document data corresponding to each reference in a reference group. The document data includes text data, and also includes image data such as drawings in some cases. Furthermore, the document data may include one or more number data selected from an application number, a publication number, and a registration number.

The input portion 110 can supply the received data to one or more selected from the memory portion 120, the processing portion 130, and the display 160 through the transmission path 150.

### [Memory Portion 120]

With the memory portion 120, the first data processing device 10 has a memory function. The memory portion 120 is a memory region and can store a program and/or data. A typical example of the program is a program executed by the processing portion 130. An example of the data is data generated by the processing portion 130 (e.g., an arithmetic result, an analysis result, or an inference result). In addition, the data includes the data received by the input portion 110.

The memory portion 120 may include a database. Examples of the database includes a database of patent documents, a database of reference groups, and a database of a user's operating history (including a search history). The memory portion 120 has a function of storing databases and can further manage them. Management includes removing unnecessary data as appropriate.

A database is not necessarily included in the memory portion 120. In addition to the database included in the memory portion 120, a data base existing outside the first data processing device 10 can be used as the database. Examples of the database which exists outside include databases where patent publications are accumulated by patent administrators in each country.

The memory portion 120 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase-change random access memory (PRAM), a ferroelectric random access memory (FeRAM), a magnetoresistive random access memory (MRAM, also referred to as a magnetoresistive memory), and a flash memory. The memory portion 120 can include a Si LSI (a circuit including silicon transistors).

The memory portion 120 may include at least one of a NOSRAM (registered trademark) and a DOSRAM (registered trademark). The memory portion 120 may include a recording media drive. Examples of the recording media drive include a hard disk drive (HDD) and a solid-state drive (SSD).

The NOSRAM is an abbreviation for a nonvolatile oxide semiconductor random access memory (RAM). The NOSRAM includes a two-transistor (2T) or three-transistor (3T) gain memory cell and refers to a memory including transistors whose channel formation regions are formed using a metal oxide (also referred to as OS transistors). OS transistors have an extremely low current that flows between their sources and drains in an off state, that is, an extremely low leakage current. The NOSRAM can be used as a nonvolatile memory by retaining electric charge corresponding to data in the memory cell, using the characteristic of an extremely low leakage current. In particular, the NOSRAM is capable of reading retained data without destruction (non-destructive reading), and thus is suitable for arithmetic processing in which only a data reading operation is repeated many times. NOSRAM memory cells can be stacked. Stacking NOSRAM memory cells enables an increase in data capacity and thus enables an improvement in performance when used as a large-scale cache memory, a large-scale main memory, or a large-scale storage memory.

The DOSRAM is an abbreviation for a dynamic oxide semiconductor RAM and refers to a RAM including a one-transistor (1T) and one-capacitor (1C) memory cell. The DOSRAM is a DRAM formed using an OS transistor and refers to a memory which temporarily stores data sent from the outside. The DOSRAM is a memory utilizing the low off-state current of the OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide contained in the channel formation region preferably includes indium (In). An OS transistor formed using a metal oxide containing indium in its channel formation region has a high carrier mobility (electron mobility). The metal oxide contained in the channel formation region is preferably an oxide semiconductor containing an element M described later instead of or in addition to In. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. The metal oxide may contain a combination of a plurality of the elements listed as the element M. The element M is an element having a high bonding energy with oxygen, and its bonding energy with oxygen is higher than the bonding energy of indium with oxygen. The metal oxide contained in the channel formation region is preferably a metal oxide containing zinc (Zn) instead of or in addition to In. The metal oxide containing zinc is easily crystallized in some cases.

The metal oxide contained in the channel formation region is not limited to the metal oxide containing the above element, typically, indium. For example, the metal oxide contained in the channel formation region is preferably a metal oxide that does not contain indium such as zinc tin oxide and gallium tin oxide; a metal oxide containing zinc, a metal oxide containing gallium, a metal oxide containing tin, or the like can be typically used.

### [Processing Portion 130]

With the processing portion 130, the first data processing device 10 has a function of performing processing such as arithmetic operation, analysis, and inference. Typically, the processing such as arithmetic operation, analysis, and inference can be performed using data supplied from one or both of the input portion 110 and the memory portion 120. In addition, data can be obtained from the memory portion 120, and the processing such as arithmetic operation, analysis, and inference can be performed using the obtained data.

Data (e.g., an arithmetic result, an analysis result, or an inference result) processed by the processing portion 130 can be supplied to one or both of the memory portion 120 and the output portion 140. For example, the data can be supplied to the memory portion 120 through the transmission path 150.

In the case where the first data processing device 10 includes the display 160, the processing portion 130 preferably also has a function of producing display data. The processing portion 130 preferably produces display data having an easy-to-see layout on the display 160 for the user. Needless to say, the display 160 can have a layout according to the user's setting.

The processing portion 130 includes at least an arithmetic circuit. For example, a central processing portion (CPU) can be included as the arithmetic circuit. The CPU includes an arithmetic unit, a primary cache memory, a secondary cache memory, and the like. The processing portion 130 may include a graphics processing portion (GPU) in addition to or instead of a CPU. The GPU includes an arithmetic unit, a primary cache memory, a secondary cache memory, and the like. A switch or the like included in the CPU or the GPU can be one or both of an OS transistor (a transistor using an oxide semiconductor layer for a channel formation region) and a Si transistor (a transistor using a semiconductor layer containing silicon for a channel formation region).

The processing portion 130 may include a register and a main memory in addition to the CPU. The register and the main memory are sometimes included in the CPU. The main memory can transmit and receive data to and from the secondary cache or the like. The main memory includes at least one of a volatile memory such as a RAM and a nonvolatile memory such as a read only memory (ROM). The main memory may include at least one of a NOSRAM and a DOSRAM. The main memory can include one or both of an OS transistor and a Si transistor. Note that when the CPU in this paragraph is replaced with the GPU, the structures of the register and the main memory can be understood.

Examples of the RAM include a DRAM and an SRAM. In a DRAM or an SRAM, a virtual memory space can be assigned and utilized as a working space of the processing portion 130. An operating system, an application program, a program module, program data, a look-up table, and the like which are stored in the memory portion 120 are loaded into the RAM immediately before execution. The operating system, the application program, the program module, the program data, and the look-up table which are loaded into the RAM can be accessed from the processing portion 130.

A system that does not require rewriting or the like can be stored in the ROM. As the system that does not require rewriting, firmware such as a basic input/output system (BIOS) can be given. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing portion 130 may include a microprocessor such as a digital signal processor (DSP) in addition to the CPU or the GPU. The DSP is specialized in digital signal processing and is thus preferably included to control a peripheral circuit and the like of the CPU or the GPU. The microprocessor may be configured with a programmable logic device (PLD), which is operated by hardware, such as a field programmable gate array (FPGA) or a field programmable analog array (FPAA). The processing portion 130 may include a quantum processor. The processing portion 130 can interpret instructions from various kinds of programs with use of a processor such as the quantum processor and execute various kinds of data processing and program control. The programs to be executed by the processor are stored in at least one of a memory region of the processor and the memory portion 120.

The OS transistor has an extremely low off-state current; therefore, with the use of the OS transistor as a switch for retaining electric charge (data) that has flowed into a capacitor, a long data retention period can be ensured. When at least one of a register and a cache memory included in the processing portion 130 has such a feature, the processing portion 130 can be operated only when needed, and otherwise can be supplied with no signal and electric power while data processed immediately before turning off the processing portion 130 is stored in the memory element. In other words, the OS transistor enables normally-off computing and reduces the power consumption of the search support system.

When a CPU or the like capable of high-speed operation is used in the processing portion 130, AI can be used for part of processing executed by the first data processing device 10. The first data processing device 10 preferably includes an artificial neural network (ANN, hereinafter also simply referred to as a neural network) to enable processing using AI. Since the neural network can be implemented by a circuit (hardware) or a program (software), the first data processing device 10 preferably includes the circuit or the program in addition to the CPU capable of high-speed operation.

In this specification and the like, the neural network indicates a general model having the capability of solving problems, which is modeled on a biological neural network and determines the connection strength of neurons by learning. The neural network includes an input layer to which data is input, an output layer from which data is output, and an intermediate layer (a hidden layer) between the input layer and the output layer, and a weight for input data is optimized in order to obtain a correct output result.

In the description of the neural network in this specification and the like, to determine a weight coefficient between neurons from the existing data is referred to as “learning” in some cases.

In this specification and the like, to draw a new conclusion from a neural network formed with a weight coefficient obtained by learning is referred to as “inference” in some cases.

### [Output Portion 140]

With the output portion 140, the first data processing device 10 has a function of outputting an arithmetic result or the like to the outside. For example, the output portion 140 can output an arithmetic result or the like from the processing portion 130 to the outside of the first data processing device 10. An example of the outside is one or more selected from the second data processing device 40 and the information terminal 20.

### [Transmission Path 150]

The transmission path 150 has a function of transmitting data. Data transmission and reception among the input portion 110, the memory portion 120, the processing portion 130, the output portion 140, and the display 160 can be performed through the transmission path 150.

### <<Structure Example of Second Data Processing Device 40>>

Next, a structure example of the second data processing device 40 is described.

The second data processing device 40 can process received data and transmit the result of the processing. For example, the second data processing device 40 can perform processing such as arithmetic operation using data received from the first data processing device 10. In addition, the second data processing device 40 can transmit the result of the processing to the first data processing device 10. Accordingly, the load of arithmetic operation on the first data processing device 10 can be reduced.

The second data processing device 40 can perform processing using a natural language processing model using generative AI. For example, the second data processing device 40 can execute processing using a natural language processing model such as bidirectional encoder representations from transformers (BERT) or text-to-text transfer transformer (T5).

The second data processing device 40 can also perform processing using a model (e.g., a document generation model or an interaction model) utilizing a large language model. For example, processing can be executed using a large language model such as GPT-3, GPT-3.5, GPT-4, language model for dialogue applications (LaMDA), pathways language model (PaLM), or Llama2.

The second data processing device 40 can execute processing using a general-purpose language processing model capable of performing a variety of natural language processing tasks.

Note that in the search support system, a search support service provider does not necessarily own the second data processing device 40 by itself. For example, the service provider can utilize part of a service provided by another service provider or the like using the second data processing device 40.

### <<Structure Example of Information Terminal 20>>

The information terminal 20 has a function of inputting data by the user. The information terminal 20 can provide data output from the search support system to the user. That is, in the search support system, it is preferable that the user operate the information terminal 20 and not operate the first data processing device 10 and the second data processing device 40. This structure can improve the security.

In the case where a service provider using the search support system and the user who enjoys the service belong to the same organization such as a company, data transmission and reception between the information terminal 20 and the first data processing device 10 is preferably performed using the network 31 constructed in the organization, for example. Thus, data can be transmitted and received between the information terminal 20 and the second data processing device 10 more safely than in the case where data is transmitted and received via the Internet. In addition, confidential data in the organization can be prevented from leaking to the outside. Alternatively, data transmission and reception between the information terminal 20 and the first data processing device 10 may be performed using the network 30 (e.g., the Internet).

Dedicated application software, a web browser, or the like are preferably installed on the information terminal 20, for example. The user can also access the first data processing device 10 through the application software or the web browser. Thus, the user can enjoy a service using the search support system with the use of the information terminal 20 whose processing capability is lower than that of the first data processing device 10.

### <<Network 30>>

The network 30 is an example of a network connecting the first data processing device and the second data processing device 40. Thus, input data and processed data can be transmitted and received between the information processing device 10 and the information processing device 40. In addition, a load related to data processing can be balanced.

For example, a global network can be used as the network 30. Specifically, the Internet, which is an infrastructure of the World Wide Web (WWW), can be used as the global network. The network 30 is preferably a larger computer network than the network 31.

### <<Network 31>>

The network 31 is an example of a network connecting the information terminal 20 and the first data processing device 10. Thus, data can be transmitted and received between the information terminal 20 and the information processing device 10. In addition, a load related to data processing can be balanced. Furthermore, the service provider can provide a service using the search support system to the user through the network 31, for example.

For example, a local network can be used as the network 31. An intranet or an extranet can be used as the network 31. A personal area network (PAN), a local area network (LAN), a campus area network (CAN), a metropolitan area network (MAN), a wide area network (WAN), a global area network (GAN), or the like can be used as the network 31.

For wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

### Example 1 Related to Method

In this embodiment, the search support method of one embodiment of the present invention is described in a way that the method is divided into steps. In this search support method, steps described later are desirably executed in the described order, but the execution order is not necessarily limited thereto.

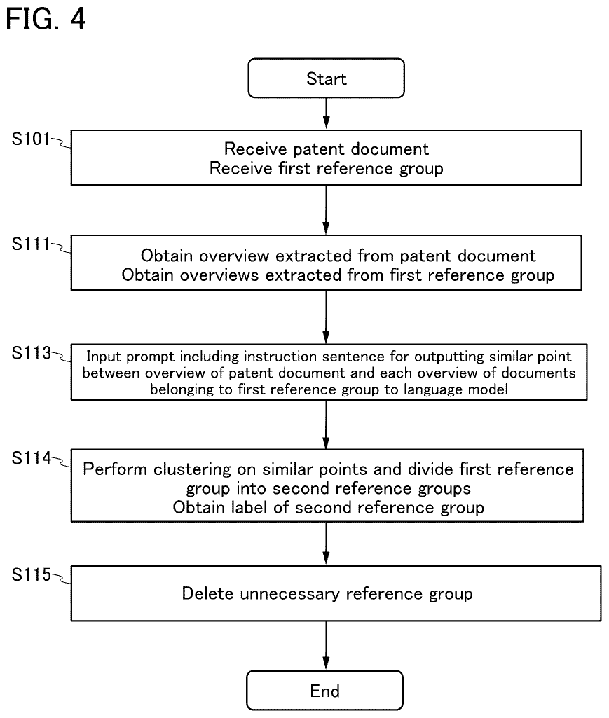

FIG. 4 shows an example of a flowchart of steps relating to the search support method of one embodiment of the present invention. Note that the search support method of one embodiment of the present invention is started after user's login. The operating history (including the search history) of the user can be linked to the login data.

### <Step S101>

As shown in Step S101 in FIG. 4, the search support system receives a patent document where a user wants to receive a support of searching. In addition, in Step S101, the search support system receives a reference group where a user wants to receive a support of searching. The reference group to be subjected to search support is referred to as a first reference group. There is no particular limitation on the reception order, and the patent document and the first reference group can be received in the same step.

The first reference group can be prepared by the user. For example, the first reference group can be collected by the user using a search tool provided with the search support system. The first reference group can be collected by the user using a search tool other than the search support system. In addition, the first reference group can be prepared by the search support system. For example, the first reference group can be linked to the user's login data.

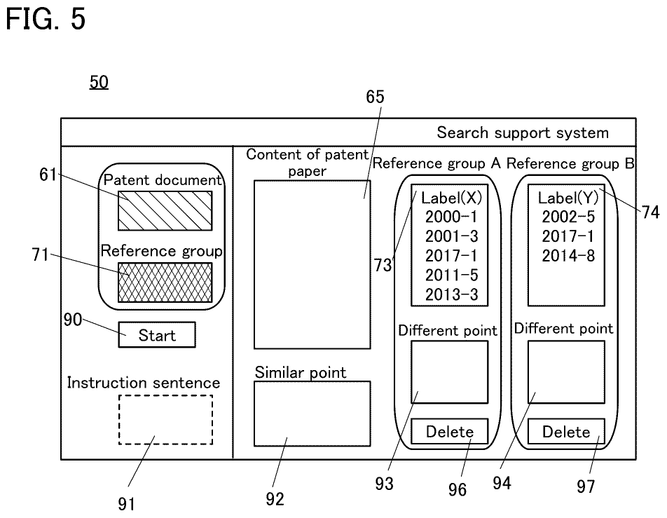

The input work by the user corresponding to Step S101 is performed by the information terminal 20. FIG. 5 illustrates an example of a screen 50 that might be displayed on the information terminal 20. Since the setting of the screen 50 can be determined by the user, the layout in the screen 50 is not limited to that in FIG. 5.

The screen 50 preferably includes an input box 61 for inputting the patent document in accordance with Step S101. The contents of the patent document input to the input box 61 can be displayed on a box 65.

The screen 50 preferably includes a text box 71 for inputting the first reference group in accordance with Step S101. For example, with input of the link of a folder where the first reference group is stored to the text box 71, the first reference group can be uploaded to the search support system. The screen 50 may additionally include a box for displaying each content of documents (literatures) belonging to the first reference group or a box for displaying the first reference group in a list form, for example.

Main data processing related to Step S101 is preferably executed by the first data processing device 10. One example of the main data processing is processing in which the input portion 110 receives data from the information terminal 20 and the data is supplied to one or both of the memory portion 120 and the processing portion 130 through the transmission path 150.

### <Additional Function 1: List Button>

An additional function 1 of the screen 50 is described. Although not illustrated in FIG. 5, the screen 50 may include a list button for displaying a plurality of patent documents in a list form instead of or in addition to the input box 61. Although not illustrated in FIG. 5, the screen 50 may include a list button for displaying the first reference group in a list form instead of or in addition to the text box 71.

As preferable specifications of the above-described list button, two or more patent documents are displayed in a list form when the user selects the list button. A user can select a patent document to be subjected to the search support from the list. Note that by replacing the patent document with the first reference group, the specification of the list button for displaying the first reference group in a list form can be understood.

The above-described list can be stored in the database included in the memory portion 120 or the database outside the first data processing device 10. In this case, the patent document selected from the list is transmitted to the information terminal 20 through the output portion 140, and the user can check the content with the box 65 or the like. Note that by replacing the patent document with the first reference group, the specification for checking the content of any one of the documents belonging to the first reference group can be understood. In this case, the screen 50 preferably includes an additional box for displaying the content of any one of the documents belonging to the first reference group.

### <Additional Function 2: Search Button>

An additional function 2 of the screen 50 is described. Although not illustrated in FIG. 5, the screen 50 may include a search button for searching through a plurality of patent documents stored in a database instead of or in addition to the input box 61. Although not illustrated in FIG. 5, the screen 50 may include a search button for performing a search through reference groups stored in a database instead of or in addition to the text box 71.

As preferable specifications of the above-described search button, a box for inputting a search term enabling general patent search is displayed. The box for inputting a search term may be displayed in a new screen different from the screen 50. With such an additional function, the user can select the patent document in consideration of a general patent search result. When the patent document is replaced with the first reference group, the specification of the search button for the first reference group can be understood.

The search can be mainly executed by the processing portion 130 of the first data processing device 10. This search can use the database included in the memory portion 120 or the database outside the first data processing device 10 as in the case of storing the above-described list to be displayed. The search result is transmitted to the information terminal 20 via the output portion 140 and the user can see it. The content of the patent document selected from the search result can be checked with the box 65. Note that by replacing the patent document with the first reference group, the content of any one of the documents belonging to the first reference group can be checked. In this case, the screen 50 may additionally include a box for displaying the content of any one of the documents belonging to the first reference group.

The search support system can have both the additional function 1 and the additional function 2.

### <Step S111>

Next, as shown in Step S111 in FIG. 4, the search support system obtains an overview (sometimes referred to as an abstract) extracted from the patent document. In Step S111, overviews each of which is extracted from any one of documents belonging to the first reference group are obtained. Step S111 is referred to as an extraction work. There is no particular limitation on the order of the extraction work, and the extraction works for the patent document and the first reference group can be performed in the same step.

As the extraction work, the content described in a specific section of the patent document can be extracted as an overview. The specific section can be specified by the user. Typical examples of the specific section include an abstract, objects, the scope of claims, any of examples, and any of embodiments in the patent document. Furthermore, when the patent document is replaced with each document belonging to the first reference group, the extraction work for each document belonging to the first reference group can be understood. Although each document belonging to the first reference group does not have an abstract, objects, the scope of claims, examples, embodiments, or the like in some cases, the user can select a section corresponding to an abstract, objects, the scope of claims, examples, embodiments, or the like as appropriate. Note that the section specified in the patent document preferably discloses contents equivalent to those of the section specified in each document belonging to the first reference group. For example, in the case where the section specified in the patent document and the section specified in each document belonging to the first reference group have the same title or substantially the same title, they can be determined to disclose the contents equivalent to each other. By such specification, variation in the extraction result can be inhibited. In this manner, the search support system can obtain overviews.

Since the search support system can progress processing of Step S111 automatically, the screen 50 does not need a display related to this step. Needless to say, the screen 50 can perform a display related to Step S111. Although not illustrated, the screen 50 preferably displays a standby time taken to process this step.

Main data processing related to Step S111 is preferably executed by the first data processing device 10. One example of the main data processing is processing by the processing portion 130 which generates an arithmetic result, an analysis result, or an inference result.

### <Variation Example of Step S111>

The extraction work in Step S111 may be performed using generative AI. In this case, the patent document is referred to as an original text in some cases. In addition, each document belonging to the first reference group is referred to as an original text in some cases. An original text and an instruction sentence (such as a sentence “Create an overview of the following documents.” with a list of patent documents and the like) are input to a language model, typically the LLM, as a prompt, so that an overview can be extracted. In the case of extracting an overview, the user can specify a paragraph or a section in the patent document. In this case, the search support system enables the specified paragraph or section to be set as an original text. “Set” means listing the specified paragraph or section in an instruction sentence. As another example of the instruction sentence, “Create an overview of the specified section below.” can be given.

In addition, the user can also set a keyword for the patent document and each document belonging to the first reference group. In the overview extraction with a specified keyword, the search support system can create an instruction sentence including the specified keyword. In the case where a keyword is set, “Create an overview using the “keyword” related to the document below.” is preferably used as a specific example of the instruction sentence. Note that in the search support system, it is preferable that one or more instruction sentences be prepared as a fixed phrase in advance and the user select an instruction sentence therefrom.

In Step S111 using generative AI, a step where the user checks an overview can be added. For the check, the screen 50 in the search support system preferably includes an additional box for displaying the overview of the patent document. Similarly, the screen 50 preferably includes an additional box for displaying each overview of the documents belonging to the first reference group.

Also in the case of using generative AI, the search support system can process Step S111 automatically, the screen 50 does not need a display related to this step. Needless to say, the screen 50 may perform a display related to Step S111. Although not illustrated, the screen 50 preferably displays a standby time taken to process this step.

Although not illustrated, main data processing related to Step S111 using generative AI is preferably performed in the second data processing device 40. The use of generative AI improves the accuracy of overviews.

### <Step S113>

Next, in Step S113 in FIG. 4, a point similar to the overview of the patent document (sometimes referred to as a matching point) is obtained from each overview of the documents belonging to the first reference group using generative AI. The same generative AI as the variation example of Step S111 can be used. With the use of the same generative AI, history data on Step S111 can be utilized, so that a similar point can be obtained in high accuracy in Step S113. Needless to say, the generative AI in Step S113 may be different from that in Step S111.

In this step, it is preferable that original text be the overview of the patent document and each overview of the documents belonging to the first reference group, which are obtained in the previous step. In this step, the user can select the output method of the similar point. An instruction sentence only needs to instruct extraction of a similar point between the overview of the patent document and each overview of the documents belonging to the first reference group. Typically, the instruction sentence can be such that “Extract a similar point between the overview of the patent document and each overview of the documents belonging to the first reference group”. In the search support system, it is preferable that one or more candidates for an instruction sentence be prepared as a fixed phrase in advance, and the user select an instruction sentence therefrom. Furthermore, it is possible that the search support system output a similar point in a state where the user specifies a keyword. For example, a keyword specified by the user in consideration of the overview of the patent document is prepared, and then the instruction sentence, “Extract a similar point relating to the “keyword” from each overview of the documents belonging to the first reference group” is used, whereby a similar point can also be obtained. This is referred to as a keyword similar point. In addition, a structure specified by the user in consideration of the overview of the patent document is prepared, and then the instruction sentence, “Output a matching portion between the structure of the overview of the patent document and each structure of the overviews of documents belonging to the first reference group” is used, whereby a similar point can also be obtained. This is referred to as a structural similar point. Such a method for outputting a similar point can also be proposed by the search support system using the user's login data. Note that a prompt including the above instruction sentences is input to the language model, typically the LLM.

Although the methods for obtaining a similar point is described above, a different point between the overview of the patent document and each overview of the documents belonging to the first reference group may be obtained with the use of generative AI. Note that in the search support system, label assignment described later is preferably performed on a similar point rather than a different point. This is due to the following reason. The overview of the patent document is presumably similar to each overview of the documents belonging to the first reference group; it can be considered that extracting a label from the overview similar to the overview of the patent document makes the processing more efficient.

As illustrated in FIG. 5, the screen 50 preferably includes a button 90 for starting processing in Step S113 as a display related to Step S113. The screen 50 preferably includes a box 91 for displaying an instruction sentence. The screen 50 preferably includes a box 92 for displaying a similar point as the display related to Step S113. Note that the similar point is obtained for each document belonging to the first reference group; thus, the similar point displayed in the box 92 is preferably linked to the corresponding reference. For example, it is preferable that a plurality of similar points be displayed in the box 92 in a list form, and when any one of them is selected, a corresponding reference be displayed. With such a screen 50, the user can check an instruction sentence in the box 91, similar points in the box 92, and the content of the patent document in the box 65.

Main data processing related to Step S113 is preferably executed by the second data processing device 40.

### <Step S114>

Next, in Step S114 in FIG. 4, the similar points between the patent document and each document belonging to the first reference group are subjected to vectorizing and clustering, and the first reference group is divided into two or more second reference groups. Typically, clustering is performed using k-means, DBSCAN, or the like, and the first reference group can be divided into two or more second reference groups on the basis of the degree of similarity in the similar points.

For vectorizing the documents, various methods can be used. For example, Bag-of-Words, BERT, or the like can be used.

The number of appearances of words may be used as a means for calculating the degree of similarity in similar points in documents. As a method for vectorizing the document using the number of appearances of words, a Term Frequency-Inverse Document Frequency (TF-IDF) or the like can be used.

Furthermore, the degree of similarity in similar points in documents can also be calculated by using the distributed representation of words instead of the number of appearances of words. As a method for vectorizing the document using the distributed representation of words, Word2vec, Doc2Vec, Sent2Vec, or the like can be used, for example.

### <Additional Function 3: Label Assignment>

Furthermore, in this step, a label is preferably obtained for each second reference group. The label is preferably a word calculated from the similarity degree of the document. Thus, the label can be obtained typically by using TF-IDF or the like. Generative AI may be used to extract the label. Specifically, the label is preferably extracted by inputting a prompt including an appropriate instruction sentence to a language model, typically an LLC, with the use of each overview of documents belonging to the second reference group as an original text. Specifically, the instruction sentence can be “Create an appropriate label expressing each of a plurality of second reference groups listed below with the use of documents belonging to the second reference groups as original texts. Reference group 1, Reference group 2, and Reference group n” (note that n is the number of reference groups belonging to the second reference group). For label extraction, it is not necessary to give all documents belonging to the second reference group in the instruction sentence. A given document is selected from any one of the second reference groups, preferably two to ten documents are selected from any one of the second reference groups. In this specification and the like, selecting a given document from a reference group is referred to as sampling.

Note that in the search support system, a document belonging to the second reference group to which Label A is assigned is allowed to belong to the second reference group to which Label B is assigned.

In accordance with Step S114, the screen 50 includes a box 73 for displaying one of the second reference groups and a box 74 for displaying another second reference group as illustrated in FIG. 5. The boxes for displaying the second reference groups are two or more. Labels can be displayed on the box 73 and the box 74 in the screen 50. Needless to say, the screen 50 may include an additional box for a label.

Main data processing related to Step S114 is preferably executed by the second data processing device 40.

### <Step S115>

Next, in Step S115 in FIG. 4, an unnecessary reference group is deleted. Specifically, the user can determine an unnecessary second reference group based on the label and the like. When the search support system receives the determination result, the reference group determined to be unnecessary is deleted from the search result.

In accordance with Step S115, the screen 50 preferably includes a delete button as illustrated in FIG. 5. Specifically, a delete button 96 corresponding to the one of the second reference groups and a delete button 97 corresponding to another second reference group are preferably included.

Main data processing related to Step S115 is preferably executed by the first data processing device 10. One example of the main data processing is processing in which the input portion 110 receives data from the information terminal 20 and the data is supplied to one or both of the memory portion 120 and the processing portion 130 through the transmission path 150.

The search support method of one embodiment of the present invention can be terminated after Step S115.

With such a search support method of one embodiment of the present invention, the user can receive support for confirming the contents of references to reduce the number of references efficiently and appropriately, so that the burden on the user can be reduced. The larger the number of documents belonging to the first reference group is, the more the effect of the search support method of one embodiment of the present invention becomes significant.

### Example 2 Related to Method

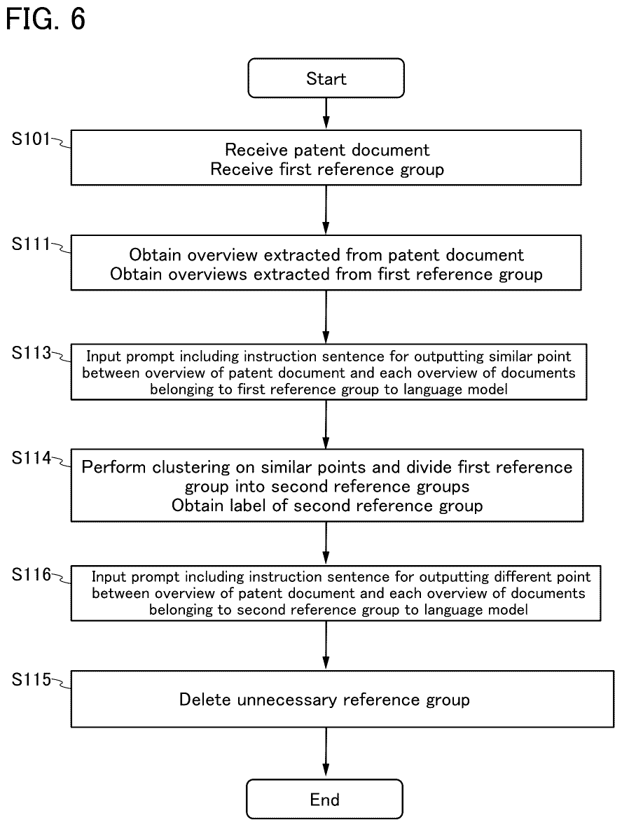

A method different from Example 1 above is described with reference to FIG. 6. Note that in Example 2, processing from Step S101 to Step S114 is the same as that in Example 1.

### <Step S116>

Next, in Step S116 in FIG. 6, a different point between the overview of the patent document and each overview of the documents belonging to the second reference group is extracted using generative AI. That is, in this step, a prompt including an instruction sentence corresponding to the above processing is input to a language model. In Step S116 in FIG. 6, a different point between a label corresponding to the second reference group and the overview of the patent document can be extracted. The different point is preferably displayed in a box 93 or a box 94 in the screen 50.

Main data processing related to Step S116 is preferably executed by the second data processing device 40.

### <Step S115>

Next, in Step S115 in FIG. 5, an unnecessary reference group is deleted. Specifically, the user can determine an unnecessary second reference group based on the different point in addition to the label. When the search support system receives the determination result, the unnecessary reference group is deleted from the search result. For this step, the description of Step S115 described in Example 1 can be referred to. Through these steps, the number of references can be reduced with high accuracy.

The search support method of one embodiment of the present invention can be terminated after Step S115.

With such a search support method of one embodiment of the present invention, the user can receive support for confirming the contents of references to reduce the number of references efficiently and appropriately, so that the burden on the user can be reduced. The larger the number of documents belonging to the first reference group is, the more the effect of the search support method of one embodiment of the present invention becomes significant.

### Example 3 Related to Method

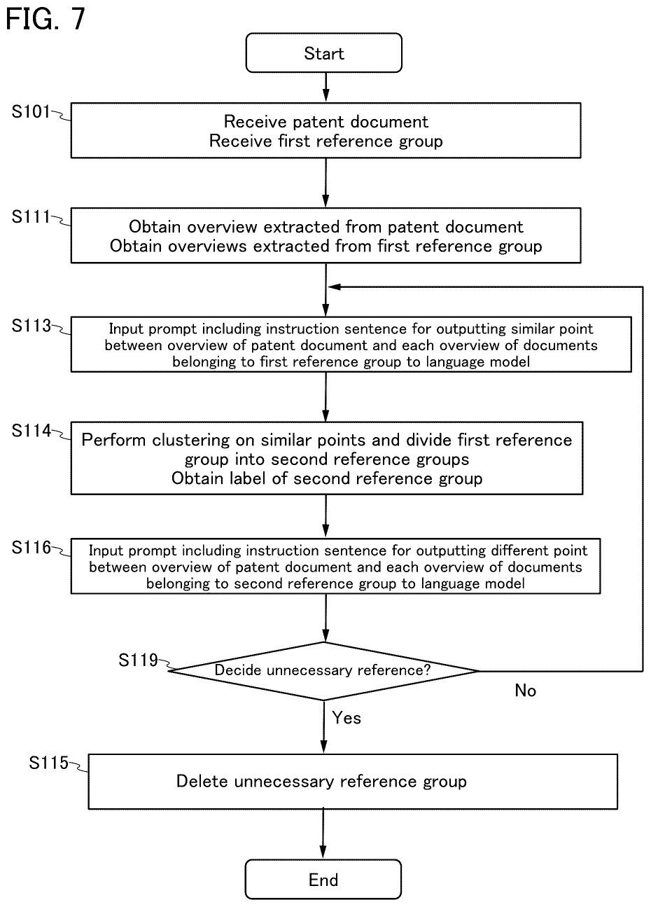

A method different from Example 1 and Example 2 is described with reference to FIG. 7. Note that processing up to Step S116 in Example 3 is the same as that in Example 2, and the search support system experiencing Step S116 has obtained a similar point and a different point.

### <Step S119>

Step S119 in FIG. 7 is preferably added in the case where the user cannot determine an unnecessary reference. In the case where the user cannot determine an unnecessary reference in Step S119 (“No” in the flowchart), the operation can return to Step S113 to extract a new similar point, for example.

In the case where the operation returns to Step S113 and the similar points obtained previously include two or more features, the screen 50 may display the features in bullet points. The user seeing the screen 50 can delete an unnecessary feature from the features in bullet points. The search support system can execute Step S113 after accepting the deletion and addition of a condition for ignoring an inappropriate feature. As a result, a new appropriate similar point can be obtained. After that, Step S114 is executed to perform clustering on similar points different from the similar points obtained previously, whereby the first reference group can be divided into new second reference groups (referred to as third reference groups), and new labels can also be obtained. Subsequently, Step S116 is executed, whereby a new different point can also be obtained.

### <Step S115>

Next, in Step S115 in FIG. 7, the user can determine an unnecessary second reference group based on the labels different from the labels obtained previously. When the search support system receives the determination result, the unnecessary second reference group is deleted from the search result. For this step, the description of Step S115 described in Example 1 can be referred to. Through these steps, unnecessary references can be reduced with higher accuracy.

### <Variation Example of Step S119>

In the case where the user cannot determine the unnecessary reference in Step S119 (“No” in the flowchart), the operation can return to Step S116 to extract a new different point. In the case where the operation returns to Step S116 and the different points obtained previously include two or more features, the screen 50 may display the features in bullet points. The user seeing the screen 50 can delete an unnecessary feature from the features in bullet points. The search support system can execute Step S116 after accepting the deletion and addition of a condition for ignoring an inappropriate feature. As a result, a new appropriate different point can be obtained.

Next, in Step S115, the user can determine an unnecessary second reference group based on the different point which is different from the different points obtained previously in addition to the labels obtained previously. When the search support system receives the determination result, the unnecessary second reference group is deleted from the search result. For this step, the description of Step S115 described in Example 1 can be referred to. Through these steps, the number of references can be reduced with high accuracy.

The search support method of one embodiment of the present invention can be terminated after Step S115.

With such a search support method of one embodiment of the present invention, the user can receive support for confirming the contents of references to reduce the number of references efficiently and appropriately, so that the burden on the user can be reduced. The larger the number of documents belonging to the first reference group is, the more the effect of the search support method of one embodiment of the present invention becomes significant.

According to this embodiment, a novel search support method can be provided.

This application is based on Japanese Patent Application Serial No. 2023-207966 filed with Japan Patent Office on Dec. 8, 2023, the entire contents of which are hereby incorporated by reference.

What is claimed is:

1. A search support method comprising:
a step of receiving a patent document and a first reference group;
a step of obtaining a first overview extracted from the patent document and a plurality of second overviews each of which is extracted from any one of documents belonging to the first reference group;
a step of inputting a first instruction sentence for outputting a similar point between the first overview and each of the plurality of second overviews to a language model;
a step of dividing the first reference group into two or more second reference groups by performing clustering on the similar points and obtaining a label for each of the second reference groups; and
a step of deleting at least one of the two or more second reference groups based on the label.

2. A search support method comprising:
a step of receiving a patent document and a first reference group;
a step of obtaining a first overview extracted from the patent document and a plurality of second overviews each of which is extracted from any one of documents belonging to the first reference group;
a step of inputting a first instruction sentence for outputting a similar point between the first overview and each of the plurality of second overviews to a language model;
a step of dividing the first reference group into two or more second reference groups by performing clustering on the similar points and obtaining a label for each of the second reference group;
a step of inputting a second instruction sentence for outputting a different point between the first overview and each of the second reference groups to the language model; and
a step of deleting at least one of the two or more second reference groups based on the label and the different point.

3. A search support method comprising:
a step of receiving a patent document and a first reference group;
a step of obtaining a first overview extracted from the patent document and a plurality of second overviews each of which is extracted from any one of documents belonging to the first reference group;
a step of inputting a first instruction sentence for outputting a first similar point between the first overview and each of the plurality of second overviews to a language model;
a step of dividing the first reference group into two or more second reference groups by performing clustering on the first similar points and obtaining a first label for each of the second reference groups;
a step of inputting a second instruction sentence for outputting a different point between the first overview and each of the second reference groups to the language model;
a step of extracting a second similar point when a user cannot determine a second reference group to be deleted based on the label;
a step of dividing the first reference group into two or more third reference groups by performing clustering on the second similar points and obtaining a second label for each of the third reference groups; and
a step of deleting at least one of the two or more third reference groups based on the second label.

4. A search support method comprising:
a step of receiving a patent document and a first reference group;
a step of obtaining a first overview extracted from the patent document and a plurality of second overviews each of which is extracted from any one of documents belonging to the first reference group;
a step of inputting a first instruction sentence for outputting a similar point between the first overview and each of the plurality of second overviews to a language model;
a step of dividing the first reference group into two or more second reference groups by performing clustering on the similar points and obtaining a label for each of the second reference group;
a step of inputting a second instruction sentence for outputting a first different point between the first overview and each of the second reference groups to the language model;
a step of extracting a second different point when a user cannot determine a reference group to be deleted based on the label; and
a step of deleting at least one of the two or more second reference groups based on the label and the second different point.
